(19) United States
(12) Patent Application Publication
(10) Pub. No.: US 2013/0097296 A1
(43) Pub. Date: Apr. 18, 2013

(54) SECURE CLOUD-BASED VIRTUAL MACHINE MIGRATION

(71) Applicants: Christian Gehrmann, Lund (SE); Mats Näslund, Bromma (SE); Makan Pourzandi, Montreal (CA)

(72) Inventors: Christian Gehrmann, Lund (SE); Mats Näslund, Bromma (SE); Makan Pourzandi, Montreal (CA)

(73) Assignee: TELEFONAKTIEBOLAGET L M ERICSSON (PUBL), Stockholm (SE)

(21) Appl. No.: 13/275,722

(22) Filed: Oct. 18, 2011

(51) Int. Cl. G06F 15/173

(52) U.S. Cl. 709/223

(57) ABSTRACT

A virtual machine (VM) system is provided. The system includes a target physical server (PS) that has a resource configuration. The system includes a source PS that runs a virtual machine (VM). The source PS is in communication with the target PS. The source PS includes a memory that stores a migration policy file. The migration policy file includes at least one trust criteria in which the at least one trust criteria indicates a minimum resource configuration. The source PS includes a receiver that receives target PS resource configuration and a processor in communication with the memory and receiver. The processor determines whether the target PS resource configuration meets the at least one trust criteria. The processor initiates VM migration to the target PS based at least in part on whether the target PS resource configuration meets the at least one trust criteria.

### TECHNICAL FIELD

The present invention relates to a system and method for secure virtual machine migration from one physical server to another physical server.

### BACKGROUND

Cloud computing environments have been gaining popularity due to their ability to provide on-demand computing resources. A cloud computing environment may include hardware and software resources, e.g., one or more servers that are made available to a user through a computer network, e.g., the Internet. For example, a user may request computing resources in the cloud. The user may send information into the cloud such that one of the computing resources in the cloud allocates a part of its resources in the form of a virtual machine (VM), thereby allowing the user's information processing needs to be met. While this configuration may work for users that are not security sensitive, there are security issues associated with simply launching a virtual machine within the cloud. For example, the user often does not know which one of the servers in the cloud is actually running the virtual machine. In particular, the user may not know the operating state of the server running the virtual machine. For example, the server may be running malicious software while also running the user's virtual machine, thereby affecting the security of the user's private virtual machine data running at the server. Even if not running explicitly “hostile” software, the server may be running an operating system or software lacking security mechanisms that the user prefers.

Attestation by the server based on hardware root of trust has been implemented as a way to provide a particular level of security or trust at the server running the virtual machine in the cloud. In particular, the server attests to its security level before sending data to the user or interacting with the user. The user may obtain security level related information about the server in order to establish a trustworthy connection with the server. While this may help ensure a particular security level at the server running the user's virtual machine, security sensitive clients often have to give up efficiency at the expense of security. For example, the server running the user's virtual machine may be overloaded such that the user's virtual machine is not running at its most efficient level, i.e., may only use limited server resources. At this point, the server may transfer the virtual machine to a second server that has available resources or may continue to inefficiently process the user's virtual machine. If the server transfers the virtual machine to the second server, there is no guarantee that the security level of the second server will match or exceed that of the transferring server. For example, the second server may have available resources but may also be running malicious software such as to put the user's data processed by the virtual machine in jeopardy. Furthermore, running the user's virtual machine at the second server may increase the cost to the user. As such, blindly transferring the virtual machine to a second server within the cloud may negatively affect the user's cloud computing experience.

Alternatively, the server may not transfer the user's virtual machine to a second server, thereby helping maintain the level of security initial established between the server and the user. However, the user's virtual machine will continue to run using the limited resources at the server that may substantially increase the virtual machine running time. In other words, the user often has to choose between security virtual machine processing and efficient virtual machine processing, thereby negatively impacting the user's cloud computing experience.

Note that a server resource shortage may be caused as a result of the server simultaneously providing services to a possibly dynamically increasing plurality of users. At the same time, trust and security issues tend to be more accentuated in such scenarios. Specifically, when a server is shared among several users, there is an immediate threat that one user's confidential information could be accidentally or maliciously exposed to another user during processing at the server. Therefore, users may have a desire to obtain stronger trust and security assurance in shared cloud environments.

Accordingly, it is desirable to have a system and method that allows a server in a cloud computing environment to migrate, as needed, a user's virtual machine to another server having at least a certain, e.g., the same or higher, trust level and available processing resources.

### SUMMARY

The present invention advantageously provides a method and system for trusted virtual machine migration from one physical server to another physical server.

According to one embodiment, a source physical server (PS) is provided. The source PS includes a memory that stores a migration policy file in which the migration policy file includes at least one trust criteria. The source PS includes a receiver that receives target PS resource configuration. The source PS includes a processor in communication with the memory and receiver. The processor determines whether the target PS resource configuration meets the at least one trust criteria. The at least one trust criteria indicates a minimum resource configuration. The processor initiates VM migration to a target PS based at least in part on whether the target PS resource configuration meets the at least one trust criteria.

According to another embodiment, a virtual machine (VM) system is provided. The system includes a target physical server (PS) that has a resource configuration. The system includes a source PS that runs a virtual machine (VM). The source PS is in communication with the target PS. The source PS includes a memory that stores a migration policy file. The migration policy file includes at least one trust criteria in which the at least one trust criteria indicates a minimum resource configuration. The source PS includes a receiver that receives target PS resource configuration and a processor in communication with the memory and receiver. The processor determines whether the target PS resource configuration meet the at least one trust criteria. The processor initiates VM migration to the target PS based at least in part on whether the target PS resource configuration meets the at least one trust criteria.

According to yet another embodiment, a method is provided for trusted virtual machine (VM) migration from a source physical server (PS) to a target PS. The method includes storing a migration policy file at the source PS in which the migration policy file includes at least one trust criteria. The method includes receiving a target PS resource configuration and determining whether the target PS resource configuration meets the at least one trust criteria. The method includes initiating VM migration to a target PS based at least in part on whether the target PS resource configuration meets the at least one trust criteria.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a trusted computing system constructed in accordance with the principles of the present invention;

FIG. 2 is a is a block diagram of an alternative trusted computing system constructed in accordance with the principles of the present invention;

FIG. 3 is a flowchart of an exemplary attestation process of the present invention;

FIG. 4 is a flowchart of an exemplary security orchestration process of the present invention;

FIG. 5 is a flowchart of an exemplary VM launch message process of the present invention;

FIG. 6 is a flowchart of an exemplary VM launch process of the present invention;

FIG. 7 is a flowchart of an exemplary VM migration process of the present invention; and

FIG. 8 is a flowchart of an exemplary migration metric evaluation process of the present invention.

### DETAILED DESCRIPTION

The present invention advantageously provides a system and method that allows for secure virtual machine migration from one physical server to another physical server having a specified trust level. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

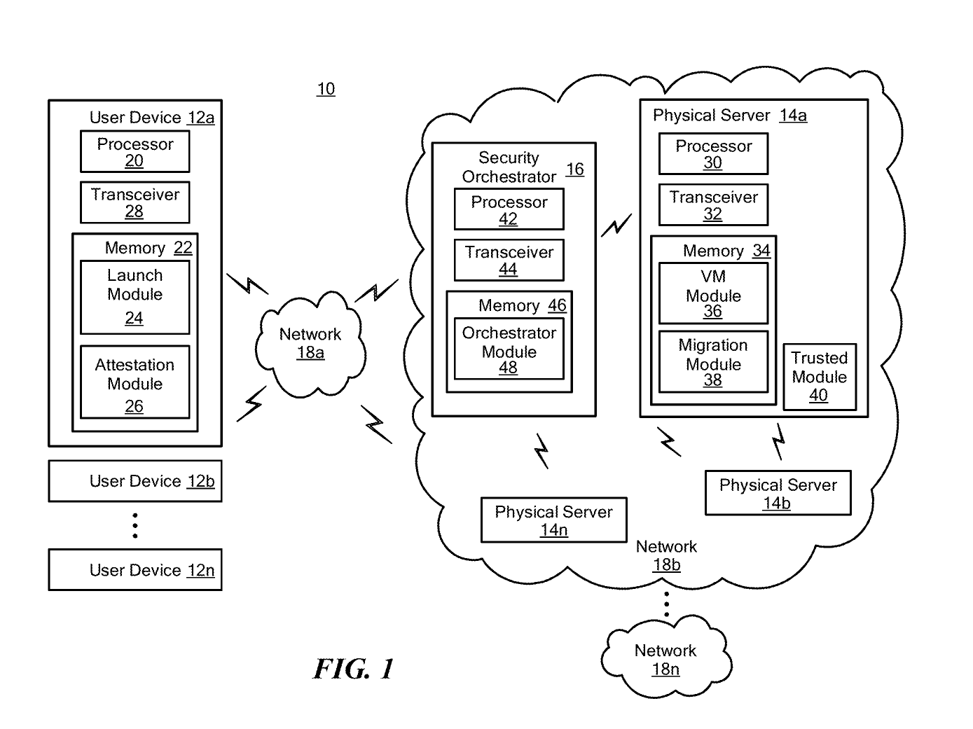

Referring now to the drawing figures in which like reference designators refer to like elements there is shown in FIG. 1 an exemplary trusted computing system constructed in accordance with the principles of the present invention and designated generally as “10.” System 10 may include one or more user devices 12a to 12n (collectively referred to as “user device 12”), one or more physical servers 14a to 14n (collectively referred to as “physical server 14”) and one or more security orchestrators 16, communicating via one or more networks 18a to 18n (collectively referred to as “network 18”).

User device 12 may include mobile devices, laptops, computers, personal digital assistants (PDAs), tablets, servers and the like. User device 12 may communicate with physical server (PS) 14, security orchestrator (SO) 16, network 18 and other communication devices (not shown) via communication protocols known in the art, e.g., Internet Protocol. User device 12 may include processor 20 and memory 22 in communication with each other. Memory 22 stores launch module 24 and attestation module 26, among other modules. Processor 20 may include a central processing unit (CPU) for performing user device functions described herein.

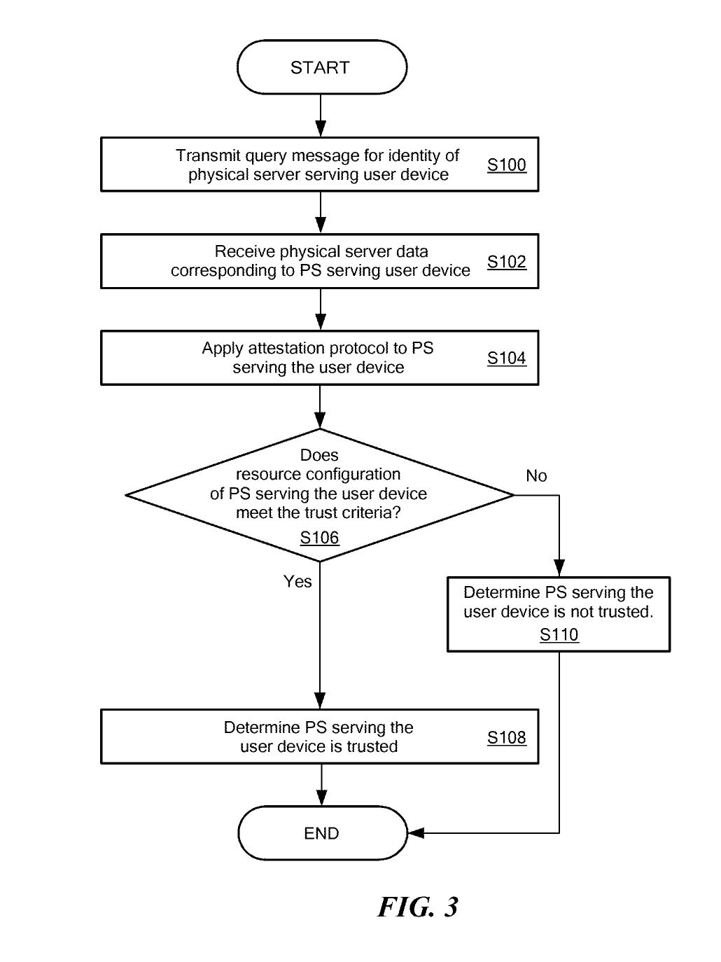

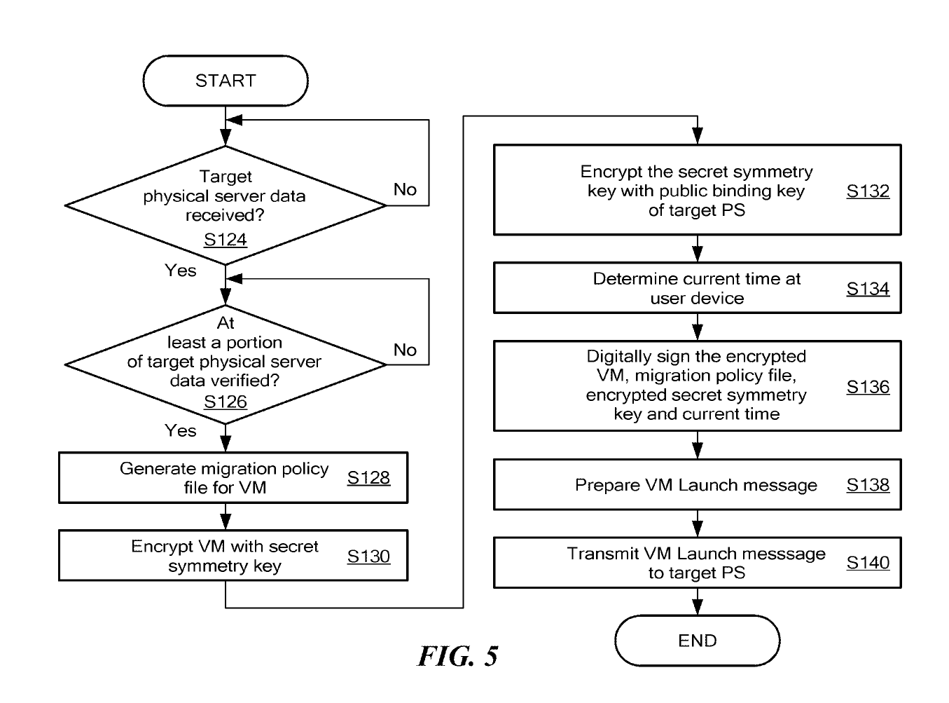

In particular, memory 22 may include non-volatile and volatile memory. For example, non-volatile memory may include a hard drive, flash memory, memory stick and the like. Also, volatile memory may include random access memory and others known in the art. Memory 22 may store program instructions such as those for launch module 24. For example, launch module 24 includes instructions, which when executed by processor 20, cause processor 20 to perform the VM launch message process, discussed in detail with reference to FIG. 5. Also, attestation module 26 includes instructions which, when executed by processor 20, cause processor 20 to perform the attestation process, discussed in detail with reference to FIG. 3. Memory 22 may store PS data, user device data, keys and certificates, resource configuration(s) of PS 14, among other data. Transceiver 28 provides transmission and reception of communications over network 18. For example, transceiver 28 may include a transmitter, receiver and the like.

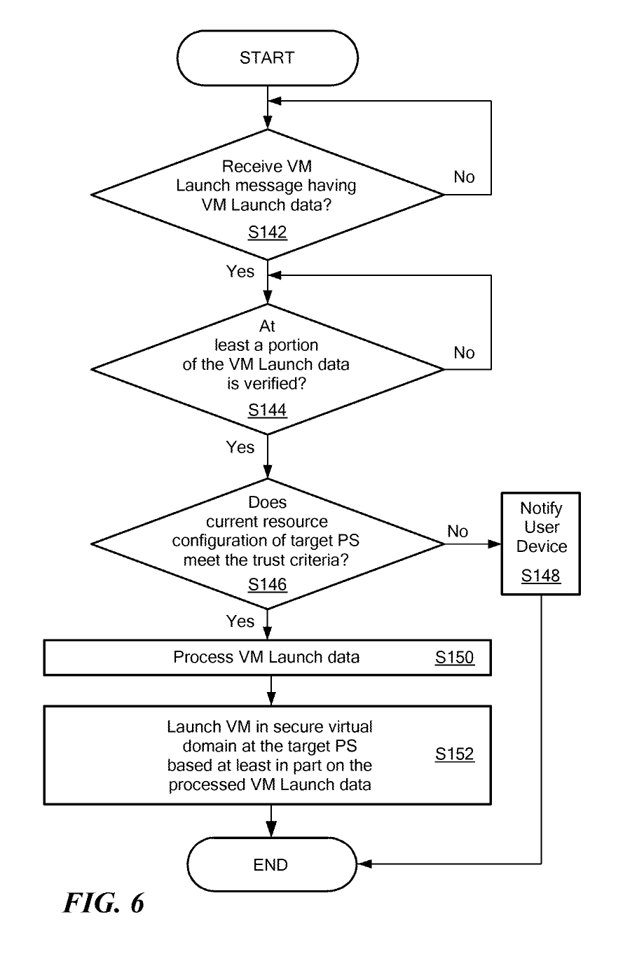

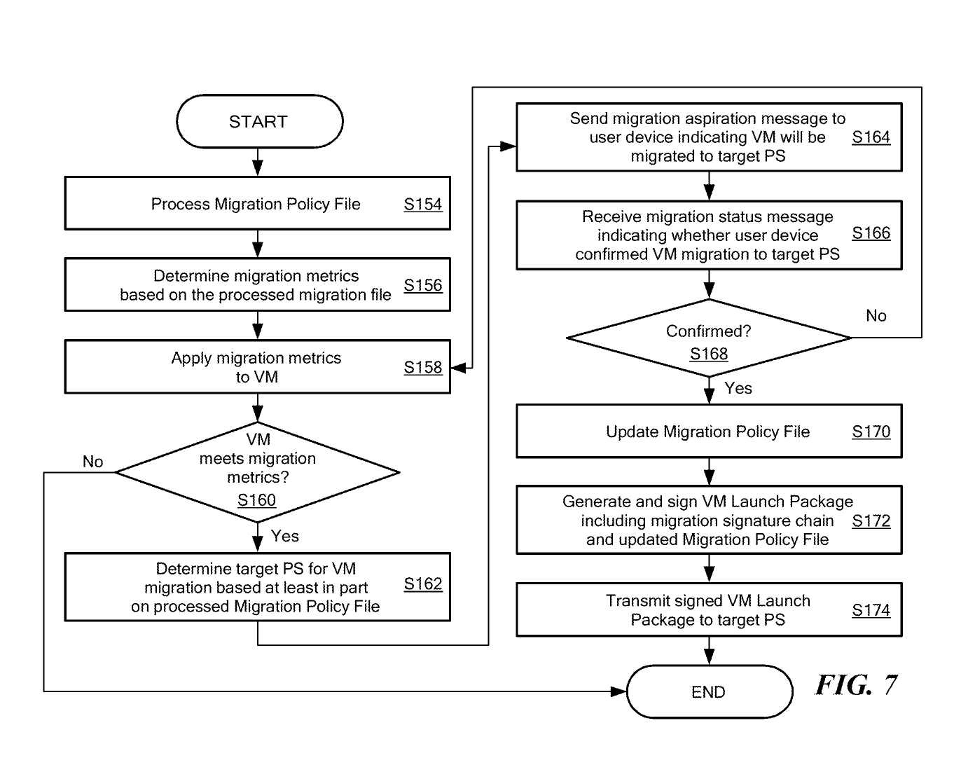

PS server 14 may include processor 30, transceiver 32 and memory 34 in communication with each other. In particular, processor 30, transceiver 32 and memory 34 may function substantially the same as the corresponding user device 12 components, with size and performance being adjusted based on design needs. Memory 34 may store VM module 36, migration module 38, among other modules. VM module 36 performs the process of launching the VM at target PS 14 based on the received VM launch message. Migration module 38 performs the process of determining whether to migrate the VM, and transmits the VM Launch package to target PS 14. VM module 36 includes instructions, which when executed by processor 30, cause processor 30 to perform the VM launch process, discussed in detail with reference to FIG. 6. Migration module 38 includes instructions, when executed by processor 30, cause processor 30 to perform the migration process, discussed in detail with reference to FIG. 7.

Memory 34 may store resource configuration(s), keys and certificates, among other data that corresponds to user device 12 or PS 14. A particular PS 14 may store resource configurations of itself, obtained by measurements as discussed below, and may also store information corresponding to resource configurations of one or more other PS 14, as obtained by remote attestation, also discussed below. In particular, the resource configuration indicates the operating state or a fingerprint of the operating state of a particular PS 14, which is indicative of the trust level of the particular PS 14. The resource configuration may include resource configuration values of PS 14 (e.g., PS 14a) in which resource configuration values may be measurements generated by a measurement kernel of PS 14 and stored in a secure portion of memory and/or in trusted module 40. Configuration values corresponding to the PS 14 may be stored in the trusted module 40, and configuration values corresponding to other PS 14 may be stored in, for example, secure parts of memory 34. In particular, the measurements may be measured values and/or hash(es) of the measured values. The measured values may be a numerical representation of embedded data, program code and/or hardware at PS 14. The hash (e.g., TH) of the measured values may be TH={H1, H2, . . . HN}, where each H1 to HN is a hash, e.g., a cryptographic hash. The hash provides a snapshot of the operating state or resource configuration of the particular PS 14, and may be indicative of a trust level of the particular PS 14. For example, the hash provides a snapshot of all the software and/or hardware present in PS 14. While memory 34 is shown and described as part of PS 14, it is contemplated that memory 34 can alternatively reside in external memory such as an external storage device (not shown).

Keys stored in memory 34 and/or in the trusted module 40 are used to secure communication between different PS 14 and between PS 14 and user device 12, e.g., to provide encryption and/or authentication of communicated information. Keys may include migratable and non-migratable keys, e.g., keys that may or may not migrate from one PS 14 to another PS 14. Migratable keys may be migrated from one resource configuration on PS 14 to another resource configuration on another PS 14. Non-migratable keys cannot be migrated and are permanently associated with a specific resource configuration on a particular PS 14, e.g., associated with a particular operating state. Furthermore, there are several types of migratable and non-migratable keys. For example, signing keys are asymmetric general purpose keys used by user device 12 and/or PS 14 to sign application data and messages. Signing keys may be migratable or non-migratable. Attestation Identity Keys (AIKs) are non-migratable signing keys that are used to sign data originated by PS 14, e.g., generated values corresponding to a resource configuration of PS 14, uses the AIK of PS 14 to sign the values. In particular, AIKs may be used to attest to the resource configuration of PS 14, e.g., attest the resource configuration values that were generated. Binding keys may be used to encrypt data on one platform and decrypt it on another platform. For example, binding key may be a symmetric key used to encrypt data at on one platform at one PS 14 and decrypt the encrypted data on another platform at another PS 14.

Moreover, certificates may include an AIK certificate that identifies the AIK private key of PS 14 and/or user device 12. The certificate may be used to sign or attest the resource configuration of PS 14; e.g., Cert_{AIK}_{_{—}}_{PS14a}, providing assurance to another PS 14 and/or user that the resource configuration is authentic. The certificate may include a public key corresponding to PS 14. The certificate may also identify a particular manufacturer and model of PS 14. The resource configuration of PS 14 (e.g., PS 14a) may be resource configuration values such as measurements generated by a measurement kernel of PS 14a, e.g., generated by target PS 14 itself.

Trusted module 40 may provide additional functionality for PS 14. In particular, trusted module 40 may provide shielded locations that are trusted to operate and store sensitive data, e.g., provide secure storage and processing. Trusted module 40 may provide generation and storage of keys such that trusted module manages keys for PS 14, e.g., keys as disclosed with respect to memory 34. For example, trusted module 40 may generate and store AIK private keys that correspond to a public key in an AIK certificate, among other types of keys that may be used in the process of FIGS. 3-8. Trusted module 40 may store certificates such as those discussed with respect to memory 34. For example, trusted module 40 may store an AIK certificate that identifies the AIK private key of PS 14. Trusted module 40 may provide resource configuration values similar to those provided by the measurement kernel of PS 14, e.g., TH.

In particular, trusted module may provide an independent and trusted process to measure the resource configuration (e.g., operating state or integrity) of PS 14. The resource configuration measurements may be stored in the shield locations such as in platform configuration registers (PCRs) that are part of and managed by trusted module 40 (not shown). Alternatively, trusted module 40 may provide storage for resource configuration measurements generate by the measurement kernel of PS 14. Trusted module may provide reporting of the resource configuration measurements stored in PCRs, e.g., transmit measurements. For example, trusted module 40 may report the resource configuration measurements by first attesting to the resource configuration measurements, e.g., authenticating the measurements using the AIK before transmitting the measurements to source PS 14 or user device 12. Trusted module 40 may be implemented in software, hardware or a combination thereof and may be included as part of PS 14 or as an additional component. For example, trusted module 40 may include components, e.g., processor, transceiver, memory, that function substantially the same as the corresponding user device 12 components, with size and performance being adjusted based on design need. In one embodiment, the trusted module 40 includes a Trusted Platform Module (TPM) operating in accordance with Trusted Computing Group (TCG) technical specifications.

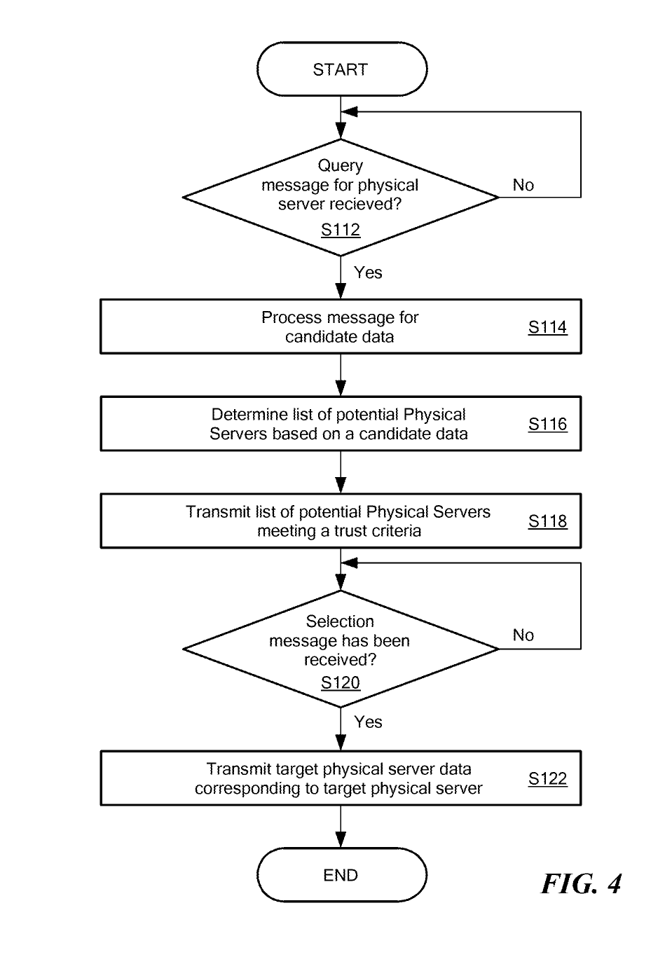

Security orchestrator (SO) 16 may include processor 42, transceiver 44 and memory 46, among components. In particular, processor 42, transceiver 44 and memory 46 may function substantially the same as the corresponding user device 12 and PS 14 components, with size and performance being adjusted based on design needs. Memory 46 may store orchestrator module 48, among other modules. Orchestrator module includes instructions, which when executed by processor 42, cause processor 42 to perform the security orchestration process of FIG. 4. Memory 46 may also store certificates, keys and resource configuration(s), among other data that corresponds to user device 12 and/or PS 14 similar to that stored in memory 34. While memory 46 is shown and described as part of PS 14, it is contemplated that memory 34 can alternatively reside in external memory such as an external storage device (not shown).

Network 18 may be any suitable communication network, e.g., an Internet Protocol (IP) network. Network 18 may be established as a wide area network (WAN), local area network (LAN), among other IP-based networks. Network 18 may include wired or wireless communication links or, any combination thereof. In particular, network 18a-18n may form one or more cloud computing environments. In particular, a cloud computing environment may include hardware and software resources that are available to user device 12. For example, the cloud computing environment may include physical servers 14a and 14b such that hardware and software resources from physical servers 14a and 14b may be used by user device 12 upon request.

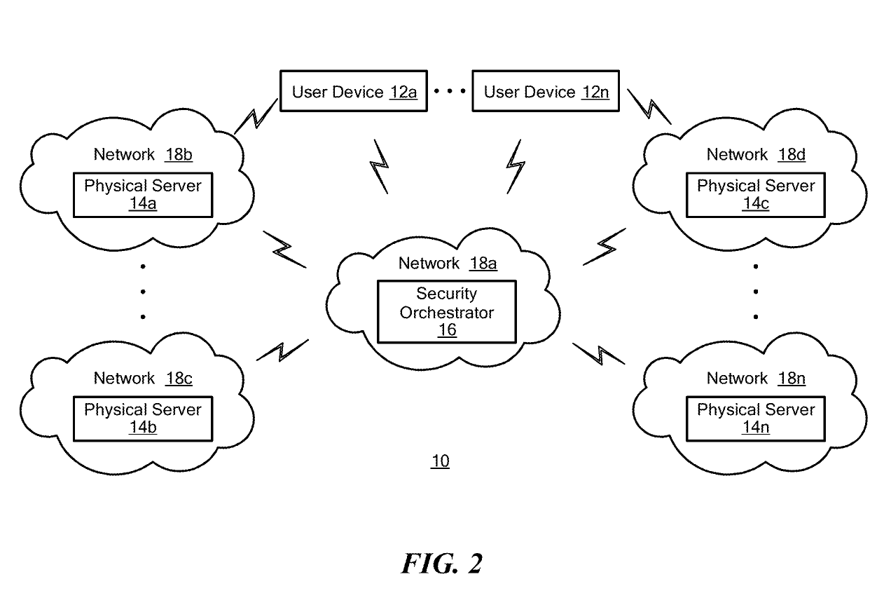

FIG. 2 illustrates another exemplary configuration of system 10. In particular, PS 14 and SO 16 may be located in different networks, i.e., different clouds. For example, SO 16 may be located within network 18a and may be in communication with physical server 14a, 14b and 14c that reside in network 18b, 18c and 18d, respectively. SO 16 provides user device 12 with the functionality to communicate with a plurality of physical servers 14 residing in a plurality of networks/clouds. As such, the configuration of FIG. 2 may provide user device 12 with various options as to which PS 14 will serve user device 12, i.e., PS 14 where a VM is launched. Also, one or more physical servers 14 may serve user device 12 at substantially the same time.

Of note, the term “source PS” used herein refers to a PS 14 which is currently running a user's VM. The term “target PS” refers to a candidate PS 14 of the user's VM. Accordingly, at launch, a candidate PS 14 is referred to as a “target PS”. Once the VM has been launched on the target PS 14, the target PS 14 becomes a “source PS” for subsequent migration.

In general, the systems of FIGS. 1 and 2 may implement the processes described in FIGS. 3-8. For example, target PS 14 may be allocated or selected to run the VM corresponding to user device 12. However, before the VM launch, user device 12 may verify that target PS is trusted as an initial platform for the VM and that target PS 14 can be trusted not to allow further migrations not allowed by the migration policy file. After VM launch, if the VM needs to be migrated, source PS 14 running the VM may verify that target PS 14 is acceptable to handle the VM, e.g., acceptability may be defined by user device 12 in the migration policy file. These processes are discussed in detail with respect to FIGS. 3-8.

An exemplary attestation process for user device 12 to verify the resource configuration of PS 14 is described with reference to FIG. 3. The attestation process may occur before VM launch, after VM launch or anytime user device 12 needs to verify the resource configuration of PS 14. The attestation process may be initiated when transceiver 28 of user device 12 transmits a query message for the identity of source PS 14 serving user device 12, e.g., identity of source PS 14 running VM resources for user device 12 (Step S100). For example, user device 12 may transmit a query message to SO 16 for the identity of source PS 14 currently serving user device 12. SO 16 may dynamically track source PS 14 or may search for source PS 14 upon receipt of the query message. User device 12 may receive, from SO 16, source PS data corresponding to source PS 14 (Step S102). Source PS data may include a certificate allowing user device 12 run an attestation protocol on source PS 14 (Step S104).

The attestation process may be initiated by user device 12 requesting an attestation certificate from source PS 14 that attest source PS 14 has a certain resource configuration, i.e., the attestation certificate is a signature over its current resource configuration. The attestation certificate of source PS 14 (Cert_{SourcePS}) is provided by source PS 14. The resource configuration of source PS 14 may be generated and signed by trusted module 40. In particular, trusted module 40 of PS 14 may, each time a software component is loaded, include a hash/fingerprint of the component into the protected memory location, e.g., shielded locations. By signing (by the trusted module, using the private attestation key) the aggregate of the hashes/fingerprints, user device 12 is provided with a trusted (signed) fingerprint of the overall operating state of PS 14, e.g., resource configuration of source PS 14. User device 12 may verify the certificate and that the resource configuration of source PS 14 meets the trust criteria (Step S106). For example, user device 12 may then verify whether the signatures are authentic (e.g., generated by the correct trusted module 40) and whether the signatures correspond to an acceptable resource configuration (e.g., trust criteria). If source PS 14 configuration is determined to meet the trust criteria, then PS 14 serving user device 12 is determined to be trusted, e.g., the resource configuration values of source PS 14 meet the threshold values indicated in the trust criteria (Step S108). if source PS 14 configuration is determined not to meet the trust criteria, then source PS 14 serving user device 12 is determined to not be trusted, e.g., the resource configuration values of source PS 14 do not meet the threshold values indicated in the trust criteria (Step S110). It is contemplated that an analogous procedure may be used by a first (source) PS 14 to obtain an attestation of the resource configuration of a second (target) PS 14.

An exemplary security orchestration process for facilitating VM launch to target PS 14 having a resource configuration is described with reference to FIG. 4. User device 12 initiates the security orchestration process by transmitting a query message to SO 16. The query message includes PS candidate data. For example, SO 16 determines whether a query message has been received (Step S112). If a query message is determine to have been received, SO 16 processes the query message for PS candidate data (Step S114). The PS candidate data may indicate a particular type of resource configuration required by user device 12 to allow the VM to run at target PS 14. For example, PS candidate data may include a trust criteria corresponding to a particular resource configuration of PS 14, PS 14 manufacturer information, among other data that may be processed by SO 16. A list of potential physical servers 14 that meet some or all of the candidate data is determined, e.g., determined by SO 16 (Step S116). For example, the trusted module 40 corresponding to each potential physical server may generate and sign the resource configuration for its corresponding PS 14. Continuing the example, SO 16 may authenticate the signatures and compare the resource configuration for each potential physical server to the trust criteria. The determined list of potential physical servers 14 is transmitted to user device 12 from SO 16 via a message (Step S118). A determination is made whether a selection message has been received from user device 12 (Step S120). In particular, the selection message may indicate which one of the potential physical servers 14 has been selected to serve user device 12, i.e., user device 12 selects target PS 14 for VM launch.

If it is determined that no selection message has been received, the determination of Step S120 may be repeated. If the selection is determined to have been received, SO 16 transmits target PS data to user device 12 (Step S122). The target PS data may include data corresponding to target PS 14 such that the target PS data may be processed by user device 12 to prepare a VM launch message, discussed in detail with respect to FIG. 5. In particular, the target PS data may include an attestation certificate of target PS 14, resource configuration of target PS 14, a public binding key corresponding to target PS 14, a resource license, among other data. The attestation certificate of target PS 14 (e.g., Cert_{targetPS}) may identify one or more secret attestation identity keys (AIKs) that are non-migratable signing keys, specific to target PS 14, that are used to sign data originated by target PS 14, i.e., the secret AIK itself is not included in the attestation certificate and may be stored in trusted module 40. For example, the attestation certificate of target PS 14 may be used to sign or attest the resource configuration of target PS 14. The attestation certificate of target PS 14 may also include one or more public signing keys that are migratable. For example, the public signing keys may be asymmetric general purpose keys that are used to sign application data and messages.

The public binding key (PK_{bind}) of target PS 14 may be used to encrypt data on one resource platform for decryption on another resource platform, e.g., PK_{bind}_{_{—}}_{targetPS}. In particular, the public binding key may be an asymmetric key that is generated during a specific resource configuration of target PS 14, typically generated when the source configuration of PS 14 meets the trust criteria. Moreover, any data encrypted with the public binding key of target PS 14 may only be decrypted by a private/secret binding key (SK_{bind}) specific to target PS 14 (i.e., secret attestation key, non-migratable asymmetric key such as SK_{bind}_{_{—}}_{targetPS}) and only while target PS 14 is operating to meet the specific resource configuration, i.e., meets the trust criteria. The public binding key of target PS 14 may be signed by the public signing key of target PS 14 included in the attestation certificate. Also, the resource license may indicate that user device 12 is authorized to use target PS 14. For example, the resource license includes license criteria that specifies what and how resources of target PS 14 can be used by user device 12. The resource license may be signed by SO 16. Accordingly, user device 12 may use the received target PS data to prepare a VM launch message as discussed in detail with reference to FIG. 5.

An exemplary VM launch message process is described with reference to FIG. 5. A determination is made whether target PS data corresponding to target PS 14 has been received (Step S124). If no target PS data is received, Step S124 may be repeated. If target PS data is determined to have been received at transceiver 28, user device 12 may process and verify whether at least a portion of the target PS data meets the resource configuration specified by user device 12 (Step S126). For example, user device 12 may verify that the resource configuration of target PS 14 meets the trust criteria specified by user device 12, e.g., that the hash corresponds to that of a security configuration acceptable to user device 12. If the verification fails, user device 12 may re-initiate the security orchestration process as discussed with respect to FIG. 4. Alternatively, SO 16 or another trusted source may re-send the target PS data to user device 12. If verification is successful, a migration policy file is generated for the VM (Step S128). The migration policy file may be generated by user device 12 based at least in part on information input from the user of user device 12. For example, user of user device 12 may input, via input mechanisms, a trust criteria, migration metrics, among other criteria and metrics.

The migration policy file may include a trust criteria, migration metrics, among other information. The trust criteria may include a specific resource configuration specified by user device 12 in which the resource configuration, e.g., as defined by hash values, corresponds to an operating state of PS 14, i.e., the resource configuration corresponds to a trust level specified by user device 12. The trust criteria may be used to assess the resource configuration of target PS 14 by comparing the trust criteria specified by user device 12 with the resource configuration of target PS 14, i.e., compare trust criteria with measured resource configuration values to assess the trust level of the resource configuration of target. PS 14. The specific resource configuration specified in the migration policy file, by user device 12, may be defined by specific threshold values or a number of hash values. The threshold values may be defined by a specific representation of embedded data, program code and/or hardware desired by user device 12, e.g., a minimum resource configuration specified by user device 12. Each hash value may correspond to a hash of at least a portion of the threshold values. For example, user device 12 may specify a trust criteria, e.g., resource configuration values, corresponding to a minimum resource configuration of PS 14, on which, user device 12 wants to run the VM.

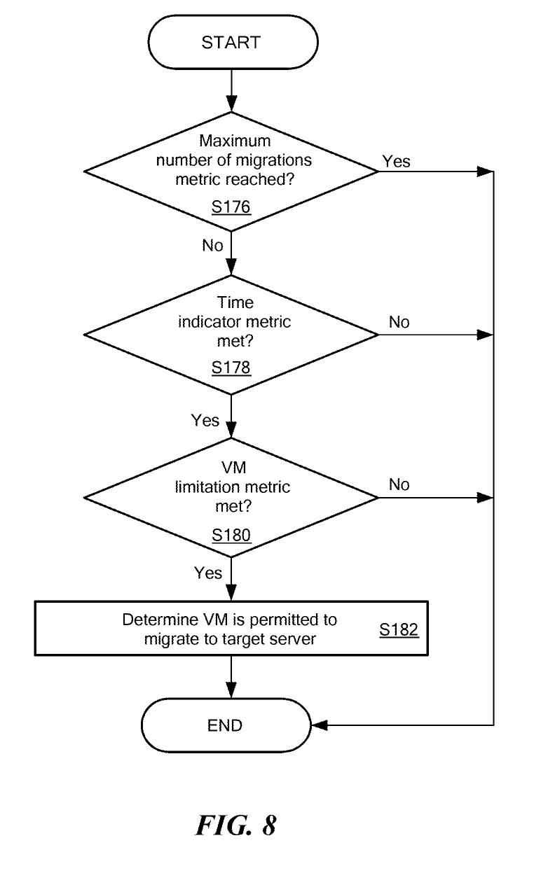

The migration metrics may include one or more metrics that indicate the conditions under which user device 12 will allow the VM to be migrated to target PS 14, i.e., metrics specified by user device 12. For example, the migration metrics may include a maximum number of migration metrics that indicates the maximum number of times the VM may migrate. For example, the maximum number of migration metrics may be a number value (e.g., 1, 3, etc.) that can be updated or decremented by source PS 14 for each migration until the value is zero, indicating no more migrations are allowed. The migration metrics may include a time indicator metric that indicates the date and time after which migration of the VM to target PS 14 is no longer allowed, i.e., indicates a permitted VM migration window. For example, the time indicator metric may indicate the specific date; hours, minutes and/or seconds after which VM migration is no longer allowed. The time indicator metric may be in a coordinated universal time (UTC) format. The migration metrics may include a VM limitation metric indicating whether certain parts of the VM may be migrated. For example, the VM limitation metric may indicate whether certain VM data may be migrated to another PS 14 after initial VM launch, i.e., indicates whether at least a portion of the VM is permitted to migrate. The migration metrics may include identifiers associated with geographical areas, service providers, or administrative domains into which the VM may (or may not) be migrated. The migration metrics are not limited to those listed here and may include other user specified or default metrics that may be used by PS 14 to determine whether to migrate the VM. An exemplary migration metric evaluation process is discussed in detail with respect to FIG. 8.

The VM may be encrypted using a secret symmetric key stored in memory 22 (e.g., Kᵥₘ) (Step S130). In particular, the secret symmetric key may be a private signing key corresponding to user device 12 that is used to generate a VM image, i.e., VM together with its identity and configuration information encrypted using the secret symmetric key (Enc_Kᵥₘ(VM, VM_{ID}, VM_{config})). The secret symmetric key (Kᵥₘ) may be encrypted with the public binding key of target PS 14 (PK_{bind}_{_{—}}_{targetPS}) received from SO 16 or a trusted source (Step S132). By using the public binding key of target PS 14 to encrypt Kᵥₘ, target PS 14 may only decrypt the encrypted Kᵥₘ using the private binding key of target PS 14 when target PS 14 is operating at a certain resource configuration, e.g., operating to meet the trust criteria specified by user device 12. The process of binding the VM to a particular PS 14 as discussed above is referred to as “sealing”. Alternatively, encryption of the VM using the secret symmetric key may be omitted, e.g., Step S130 is skipped, as the VM remains unencrypted. For example, the VM may be a cleartext image of the VM that does not have to be decrypted at target PS 14.

The current time may be determined at user device 12, e.g., time stamp T may be generated by user device 12 or by a time stamping service (Step S134). For example, user device 12 may determine the current time at user device 12 based on an internal clock and may format the determined time in UTC format. The determined time (e.g., time stamp T) may be used in the migration process to determine whether to migrate the VM, as discussed in detail with respect to FIGS. 7-8. User device 12 may digitally sign the encrypted VM, i.e., VM image, migration policy file, encrypted Kᵥₘ and current time, i.e., digital signature of user device 12 (Step S136). The digital signature of user device 12 may indicate the user device attest the data that was digitally signed. That is, besides authenticating the VM launch, this signature can serve as a proof that the user accepted the VM to be launched on a PS 14 of the particular resource configuration, i.e. indicating that the user device 12 “approved” the security/trust level of the PS 14. This may be useful in case of a later dispute between the user and the cloud service provider regarding the trust/security of the obtained resources. This signature may further also form a basis of a migration chain, discussed below. A VM launch message is prepared (Step S138). The VM launch message may include the certificate certifying the signature public key used by user device 12 (Cert_{UE}), the digital signature of user device 12 (Sign_SK_{UE}), encrypted VM, migration policy file, determined time at user device 12, encrypted Kᵥₘ (i.e., Kᵥₘ encrypted with public binding key of target PS 14), among other data. The VM launch message is transmitted to the target PS 14 (Step S140). For example, user device 12 may transmit the prepared VM launch message to target PS 14, i.e., the PS 14 that user device 12 has selected. Target PS 14 may receive and process the VM launch message as discussed in detail with respect to FIG. 6. As such, the VM launch message ensures the VM is launching at target PS 14 having a user specified trust level.

An exemplary VM launch process is described with reference to FIG. 6. A determination is made whether the VM launch message including VM launch data has been received at transceiver 32 (Step S142). If it is determined VM launch message has not been received, Step S142 may be repeated. If it is determined that the VM launch message has been received, at least a portion of the VM launch data is processed and verified, i.e., verify at least a portion of VM launch data is valid or trusted (Step S144). For example, target PS 14 may verify whether the certificate certifying the signature public key used by user device 12 (Cert_{UE}) is a trusted certificate. Also, target PS 14 may verify the digital signature in the VM launch message using the certificate (e.g., Cert_{UE}) if it is trusted. The verification Step S144 may be performed before the other VM launch data is processed, e.g., before Kᵥₘ is decrypted.

If at least a portion of the VM launch message is verified, a determination may be made as to whether the current resource configuration of target PS 14 meets the trust criteria (Step S146). For example, target PS 14 determines whether the current resource configuration values of target PS 14 meet trust criteria (e.g., hash) specified by user device 12 in the migration policy file. Note that this step may be performed at the time the VM was encrypted (or “sealed”) for this particular PS 14 as discussed above. Although user device 12 has already attested a trusted resource configuration of the PS 14, such sealing can be viewed as an additional “self-attestation” performed by the PS 14 which thus provides even higher security as compared with not including such “self-attestation.”

If it is determined that the current resource configuration of target PS 14 does not meet the trust criteria, user device 12 may be notified and/or the VM launch process may be aborted (Step S148). In particular, as a result of the aforementioned sealing, in order for target PS 14 to decrypt the encrypted Kᵥₘ with the secret binding key of target PS 14 (SK_{bind}_{_{—}}_{targetPS}), the current resource configuration must meet the trust criteria. As such, target PS 14 will be unable to decrypt the encrypted Kᵥₘ and be unable to continue processing the VM launch message until the trust criteria is met, i.e., unable to decrypt Kᵥₘ. Alternatively, the determination of Step S146 may be repeated in case the resource configuration changes over time or is updated.

If it is determined that the current resource configuration of target PS 14 meets the trust criteria, the VM launch data is processed by processor 30 (Step S150). For example, target PS 14 may decrypt the encrypted Kᵥₘ to obtain Kᵥₘ, and may then use Kᵥₘ to decrypt the VM image containing the VM and its corresponding identity and configuration information. The processed VM launch data including migration policy file, certificates, original launch message and keys may be stored in memory 34 of target PS 14. The VM is launched in a secure virtual domain at target PS 14 based on the processed VM launch data, i.e., decrypted VM image (Step S152). Once the VM is launched at target PS 14 (i.e., target PS 14 becomes source PS 14), user 12 may run an attestation process to verify or re-verify source PS 14 currently meets the trust criteria, as discussed in detail with respect to FIG. 3. Also, source PS 14 may determine whether to migrate the VM to another PS 14, as discussed in detail with respect to FIG. 7. As such, the VM is launched at target PS 14 (now source PS 14) in a secure environment having a known trust level specified by user device 12, i.e., meets trust criteria.

An exemplary VM migration process for migrating the VM to target PS 14 having a particular resource configuration is described with reference to FIG. 7. In particular, source PS 14 has launched VM and stored the migration policy file in memory 34 but source PS 14 determines it needs to migrate the VM. For example, source PS 14 may determine to migrate the VM due to factors such as locality, cost, available resources, among other factors. For example, source PS 14 may determine it is overloaded and needs to free up resources. The stored migration policy file is processed by source PS 14 (Step S154). For example, the trust criteria, e.g., resource configuration specified by user device 12, may be extracted or determined from the processed migration policy file. The processed migration policy file contains the user specified policies for allowing migration. Migration metrics are determined based at least in part on the processed migration policy file (Step S156). For example, the processed migration policy file may indicate the maximum number of times the VM can be migrated, time window for VM migration, VM migration data limitations, among metrics that restrict VM migration from source PS 14, as discussed in detail with respect to FIG. 8. The determined migration metrics are applied to the VM running at source PS 14 (Step S158). In particular, properties of the VM and/or source PS 14 may be determined and compared, by source PS 14, with the migration metrics, as discussed in detail with respect to FIG. 8, to determine whether the VM running at source PS 14 is permitted to migrate based on the migration metrics.

A determination is made as to whether the properties meet the migration metrics (Step S160). If it is determined the properties do not meet the migration metrics, migration from source PS 14 may not be allowed. In this case, user device 12 may optionally be informed and queried for input as how to handle the migration conflict. If it is determined the properties meet the migration metrics, target PS 14 is determined (Step S162). For example, source PS 14 may search for physical servers 14 in the same or other networks 18 that have free and suitable platform resources. Source PS 14 may receive PS data corresponding to the searched physical servers 14. The searching for physical servers and receipt of PS data may be performed by source PS 14, SO 16 or a combination thereof.

The received PS data may be compared to the trust criteria determined from the processed migration policy file. In particular, the trust criteria determined from the processed migration policy may indicate the trust criteria originally specified by user device 12, e.g., the originally specified trust criteria ensures the trust level or resource configuration of any subsequent physical servers 14 running the VM is adequate, e.g., meets trust criteria. Target PS 14 may be selected based at least in part on the comparison of the received PS data to the trust criteria, i.e., source PS 14 determines the resource configuration of target PS 14 meets the trust criteria. This determination may include the source PS 14 performing an explicit remote attestation procedure with the target PS 14, i.e., the target PS 14 provides the source PS 14 with an authenticated copy (signed by AIK_{TARGET}_{_{—}}_{PS}) of a measurement of its current resource configuration as discussed above.

If several physical servers 14 meet the trust criteria, source PS 14 may apply a tie-breaker criteria to select target PS 14 from one of the physical servers 14 meeting the trust criteria. For example, the tie-breaker criteria may be a preferred manufacturer, preferred type of server, target PS 14 having the highest trusted resource configuration, among other criteria inputted by user device 12 that is included in the migration policy file for selecting target PS 14. If none of the searched physical servers 14 meet the trust criteria, source PS 14 may be permitted to select target PS 14 having a slightly lower trusted resource configuration, e.g., resource configurations values of target PS 14 do not meet the trust criteria but are within a user specified range (not shown). In particular, the migration policy file may contain a time critical server metric that indicates when a second trust criteria having a lower trust level can be used to select target PS 14, e.g., VM has a time limit to finish running such that the overloaded source PS 14 is permitted to migrate the VM to a target PS 14 meeting the second trust criteria. Alternatively, the second trust criteria may indicate the VM may only be to migrated to target PS 14 having a higher trusted resource configuration. For example, the VM data associated with the VM is highly sensitive such that user device 12 will only allow the VM to be migrated to target PS 14 having a higher trusted resource configuration than current source PS 14. Alternatively, target PS 14 may have a less trusted resource configuration than source PS 14 but target PS 14 still meets the trust criteria indicated in the processed migration policy file.

After determining target PS 14, source PS 14 may transmit a migration aspiration message to user device 12 (Step S164). The migration aspiration message may indicate that the VM is going to be migrated to target PS. For example, the migration aspiration message may be displayed at user device 12, prompting the user of user device 12 to confirm or deny the migration to target PS 14. For example, user of user device 12 may decide not to allow migration to target PS and may use an input mechanism at user device 12 to indicate the denial of migration, e.g., push deny button. Upon action by the user in response to the prompting, user device 12 may transmit a migration status message to source 12 indicating whether migration was confirmed or denied. A determination is made whether a migration status message has been received from user device 12 (Step S166). The migration status message may indicate whether user device 12 confirmed or denied VM migration to target PS. Alternatively, source PS 14 may not send the migration aspiration message to user device 12 for confirmation, e.g., skip Steps S164-S168. For example, user device 12 may not be involved in the migration process such that the user of user device 12 must rely only on the current source PS 14 to migrate the VM to target PS 14 having a trusted resource configuration as specified in the migration policy file.

A determination is made whether VM migration was confirmed (Step S168). If VM migration was not confirmed, the migration metrics may be re-applied to the VM running at source PS 14, i.e., return to Step S158. If the migration status message indicates the VM migration is confirmed by user device 12, source PS 14 updates the migration policy file (Step S170). For example, the maximum number of migration metric may be updated by decrementing a count value to indicate the remaining number of migrations allowed for the VM. Also, if no more VM migrations are allowed based on the updated maximum number of migration metric, source PS 14 may update the trust criteria of migration policy file to zero, a null character or another character indicating no more VM migrations are allowed. Moreover, if no more VM migrations are allowed based on the updated maximum number of migration metric, the time indicator metric of migration policy file may be updated to zero, a null character or another character indicating the time window for migration has closed. Alternatively, updating the trust criteria and time indicator metric based on the maximum number of migration metric may be performed by target PS 14 upon VM launch by source PS 14. The updated migration policy file may include an updated trust criteria or a second trust criteria corresponding to a higher trusted resource configuration. For example, the VM may be migrated to target PS 14 operating at a trusted resource configuration exceeding that specified by user device 12 such that the trust criteria may be updated with the higher resource configuration values of target PS 14.

A VM launch package message is generated and signed by source PS 14, i.e., source PS 14 initiates VM migration based at least in part on whether migration of VM is permitted and whether the resource configuration of target PS 14 meets the trust criteria (Step S172). In particular, the VM launch packet message may be generated in a substantially similar manner to the generation of the VM launch message at user device 12, with source PS 14 acting as user device 12, i.e., the process of FIG. 5. For example, source PS 14 may receive the attestation certificate of target PS 14 (Cert_{AIK}_{_{—}}_{targetPS}) from a trusted source, e.g., from SO 16. Source PS 14 may also receive a public binding key of target PS 14 (PK_{bind}_{_{—}}_{targetPS}) signed with the public key in the attestation certificate of target PS 14. The VM launch package message may include a certificate certifying the signature public key used by source PS 14, Kᵥₘ encrypted with the public bind key of target PS 14, a VM image, updated migration policy file, current time at source PS 14 in UTC format, digital signature and migration signature chain. The secret symmetric key (Kᵥₘ) may be the same secret symmetric key included in the previous VM launch message, e.g., VM launch message from user device 12. The VM image may be the VM together with its identity and configuration information encrypted using Kᵥₘ, similar to Step S118. The digital signature may be a digital signature by source PS 14. The digital signature may include the VM image, updated migration policy file, current time at source PS 14 and the previous VM launch message that launched the VM at source PS 14. For example, the VM launch message that was received at source PS 14 may be from user device 12 or PS 14 that initiated migration of VM.

A migration signature chain may be stored in memory 34 and may indicate the signatures of user device 12 that requested the VM and every PS 14 that has run the VM. For example, the migration signature chain may provide proof or data that can be used to verify that a sequence of migrations have all taken place in accordance with the migration policy file, i.e., verify that every PS 14 that ran the VM were trusted. In particular, the migration signature chain may begin with a signature by user device 12 that requested the VM and may end with a signature by the source PS 14 currently running the VM such that then last signature of the migration signature chain is dynamically updated to account for VM migration, e.g., updated to account for new source PS 14 running the migrated VM that becomes the last signature of the migration signature chain. For example, each new source PS 14 extends the chain by signing the “old” chain and (parts of) the VM launch message as forwarded to the new target PS. The created extended chain is then passed on to the target PS 14 for further extension, and so on. This chain serves to verify that the user device trusted the initial source PS 14, and that, at every migration event, each new target PS 14 was trusted by the preceding source PS 14. The migration signature chain may indicate the chronological order of VM migration starting from user device 12 that requested the VM, including intermediary physical servers 14 that ran and migrated the VM and the current source PS 14 running the VM.

For example, the migration signature chain may be indicated by the order in which attestation certificates, digital signatures and/or public binding keys appear in the VM launch messages. The VM launch message (e.g., second VM launch message LM2) may contain an attestation certificate corresponding to source PS 14 that migrated the VM to target PS 14, e.g., may include Cert_{PS1} where source PS 14 (PS1) migrated the VM to target PS 14 (PS2). Alternatively, the VM launch message may include a hash of the certificate instead of the entire certificate. The hash of the certificate may reduce the size of the signature chains. The VM launch message (LM2) may contain the previous VM launch message (LM1) that was transmitted to source PS 14 (PS1) from user device 12 or a hash thereof. The previous VM launch message contains the attestation certificate of user device 12 (Cert_{UE}). As such, target PS 14 (i.e., new source PS 14) may determine the order of VM migration from itself (PS2), to PS 14 (PS1), then to user device 12, based on the VM launch messages stored in memory 34, i.e., LM2 links PS2 to PS1 and LM1 links PS1 to user device 12, thereby forming a migration signature chain. The attestation certificate, digital signature and/or public binding key that corresponds to user device 12 may be resource acceptance signature that begins the migration signature chain. The attestation certificate, digital signature and/or public binding key that corresponds to user device 12 may be an additional signature that starts the migration signature chain.

The signed VM launch package message is transmitted from source PS 14 to target PS 14 (Step S174) and is processed by target PS 14 in substantially the same manner as illustrated in FIG. 5. In particular, the VM launch package message is signed by source PS 14 (i.e., physical server initiating VM migration) and not user device 12.

An exemplary migration metric evaluation process is described with reference to FIG. 8. A determination is made at source PS 14 whether the maximum number of migrations metric has been reached (Step S176). In particular, the maximum number of migrations metric may be a value and/or character that indicates VM migration will be allowed if the value and/or character has not been reached. The value and/or character may be updated in the migration policy file or may remain unchanged such that source PS 14 that is applying the migration metric has to calculate the number of times the VM has been migrated based on the VM launch message. For example, PS 14 may calculate the number of migrations similar to the process of determining the migration signature chain in which each migration PS 14 leaves a footprint from the migration, e.g., certificate. If the maximum number of migrations metric has been reached, no more VM migrations are allowed, i.e., VM remains at source PS 14. If the maximum number of migrations metrics has not been reached, a determination is made whether the time indicator metric is met (Step S178). In particular, time indicator metric may indicate the date and time after which migration of the VM to another, e.g., target, PS 14 is no longer allowed or before which migration of the VM to target PS 14 is allowed. The time indicator metric may in UTC format. The time indicator metric may be compared with the current time (e.g., UTC format) at source PS 14 to determine whether VM migration is permitted. For example, the time indicator metric that indicates a specific date and time may be found to have past or expired when compared to current time at source PS 14. Alternatively, the comparison may indicate that the time indicator metric has been met, e.g., current time of source PS 14 is before the particular date and time specified in the time indicator metric.

If the time indicator metrics is met, a determination is made as to whether the VM limitation metric is met (Step S180). In particular, the VM limitation metric may indicate that certain parts of the VM may not be migrated. For example, the VM limitation metric may indicate that none, some or all of the VM data that corresponds to the VM can be migrated to another PS 14, e.g., target PS 14. The VM limitation metric may be met when the VM data corresponding to the VM to be migrated includes VM data that is permitted to be migrated. The VM limitation metric may not be met when the VM data is not permitted to be migrated, e.g., highly sensitive data that user device 12 specifies cannot be migrated. If the VM limitation metric is met, a determination is made that the VM running at source PS 14 is permitted to migrate to another server (e.g., permitted to migrate to target PS 14) (Step S182). The migration metric may provide a pre-migration process to first determine whether VM migration is permitted before source PS 14 determines target PS 14 to which to migrate the VM (e.g., Steps S160-S162). The order in which the migration metrics are applied may be varied, e.g., VM limitation metric may be applied before the time metric.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A source physical server, PS, comprising:
a memory storing a migration policy file, the migration policy file including at least one trust criteria; and
a receiver receiving a target PS resource configuration;
a processor in communication with the memory and receiver, the processor:
determining whether the target PS resource configuration meets the at least one trust criteria, the at least one trust criteria indicating a minimum resource configuration; and
initiating VM migration to a target PS based at least in part on whether the target PS resource configuration meets the at least one trust criteria.

2. The source PS of claim 1, wherein the migration policy file includes at least one migration metric, the at least one migration metric indicating whether virtual machine, VM, migration is permitted, the initiation of VM migration being based at least in part on whether VM migration is permitted.

3. The source PS of claim 2, wherein the at least one migration metric includes at least one of a time indicator metric and a migration limitation metric, the time indicator metric indicating a permitted VM migration time window, and the migration limitation metric indicating whether at least a portion of the VM is permitted to migrate.

4. The source PS of claim 1, further including a trusted module, wherein the trusted module stores a source PS certificate and the memory stores a migration signature chain, the migration signature chain being updated with information corresponding to the source PS certificate in response to the initiation of VM migration.

5. The source PS of claim 4, wherein the migration signature chain includes a resource acceptance signature, the resource acceptance signature corresponding to a user device that requested the VM.

6. The source PS of claim 4, wherein the migration signature chain includes an additional signature, the additional signature corresponding to the source PS.

7. The source PS of claim 1, wherein the target PS resource configuration is a set of measured values based on at least one of software and hardware present at the target PS.

8. The source PS of claim 1, wherein the trust criteria includes a plurality of values corresponding to a resource configuration specified by a user device.

9. A virtual machine, VM, system, the system comprising:
a target physical server, PS, having a resource configuration;
a source PS running a virtual machine, VM, the source PS being in communication with the target PS, the source PS including:
a memory storing a migration policy file, the migration policy file including at least one trust criteria, the at least one trust criteria indicating a minimum resource configuration;
a receiver receiving target PS resource configuration; and
a processor in communication with the memory and receiver, the processor:
determining whether the target PS resource configuration meets the at least one trust criteria; and
initiating VM migration to the target PS based at least in part on whether the target PS resource configuration meets the at least one trust criteria.

10. The system of claim 9, wherein the migration policy file includes at least one migration metric and the processor determines whether a VM running at the source PS is permitted to migrate based on the at least one migration metric, the initiating of migration based at least in part on whether migration of the VM is permitted.

11. The system of claim 9, wherein the target PS further includes a trusted module, the trusted module storing the target PS resource configuration and signing the target PS resource configuration received at the source PS.

12. The system of claim 9, wherein the at least one trust criteria is compared to the target PS resource configuration, the comparison indicating whether the target PS resource configuration at least equals the trust criteria.

13. The system of claim 9, wherein the trust criteria includes a plurality of values corresponding to a resource configuration specified by a user device that requested the VM.

14. The system of claim 9, wherein the source PS transmits a migration aspiration message to a user device that requested the VM, the migration aspiration message prompting the user device to confirm VM migration to the target PS.

15. The system of claim 9, wherein the target PS further includes a trusted module, the trusted module generates the target PS'resource configuration.

16. A method for trusted virtual machine, VM, migration from a source physical server, PS, to a target PS, the method, comprising:
storing a migration policy file at the source PS, the migration policy file includes at least one trust criteria;
receiving a target PS resource configuration;
determining whether the target PS resource configuration meets the at least one trust criteria; and
initiating VM migration to a target PS based at least in part on whether the target PS resource configuration meets the at least one trust criteria.

17. The method of claim 16, further comprising:
determining at the source PS whether the VM running at the source PS is permitted to migrate based on at least one migration metric, the at least migration metric being included in the migration policy file; and
initiating VM migration to the target PS based, at least in part, on whether migration of the VM is permitted.

18. The method of claim 17, further comprising:
storing a source PS certificate and migration chain signature; and
updating the migration chain signature with information corresponding to the source PS certificate in response to the initiation of VM migration, wherein the trust criteria includes a plurality of values corresponding to a resource configuration specified by a user device.

19. The method of claim 16, further comprising performing attestation on the target PS to verify whether the target PS resource configuration meets the at least one trust criteria.

20. The method of claim 16, further comprising:
receiving a VM launch message at the target PS, the VM launch message having information to launch the VM at the target PS;
verifying at least a portion of the VM launch message;
processing the VM launch message when the target PS resource configuration is operating to meet the at least one trust criteria; and
launching the VM at the target PS based at least in part on the processed VM launch message.
